(19) United States
(12) Patent Application Publication
(10) Pub. No.: US 2025/0346515 A1
(43) Pub. Date: Nov. 13, 2025

(54) Non-Biological Wastewater Treatment Systems and Methods for Treating Wastewater

(71) Applicant: Watopi Domestic ApS, Horsens (DK)

(72) Inventor: Jakob Søholm, Horsens (DK)

(21) Appl. No.: 19/276,342

(22) Filed: Jul. 22, 2025

Related U.S. Application Data
(63) Continuation of application No. PCT/DK2024/050009, filed on Jan. 23, 2024.

(30) Foreign Application Priority Data
Jan. 25, 2023 (DK) PA 2023 00067

(51) Int. Cl. C02F 9/00; B01D 19/00; B01D 21/00; B01D 21/02; B01D 21/30; B01D 21/34; B01D 61/00; B01D 61/02; B01D 61/08; B01D 61/58; B01D 65/02; C02F 1/00; C02F 1/20; C02F 1/44; C02F 101/10

(52) U.S. Cl. CPC C02F 9/00; B01D 19/0042; B01D 21/0003; B01D 21/02; B01D 21/302; B01D 21/34; B01D 61/58; B01D 65/02; B01D 61/0022; B01D 61/025; B01D 61/08; B01D 2313/50; B01D 2321/04; C02F 2001/007; C02F 1/20; C02F 1/441; C02F 1/445; C02F 2101/101; C02F 2209/40; C02F 2209/42; C02F 2303/16

(57) ABSTRACT

A non-biological wastewater treatment system comprising a water extraction unit having a forward osmosis water extraction unit and a draw recovery system that is connected to and configured to receive a diluted draw solution from the forward osmosis water extraction unit, wherein the non-biological wastewater treatment system comprises a phase separation and clarification tank, wherein the tank comprises an inlet connected to a first compartment and one or more additional compartments, wherein each compartment is separated from adjacent compartments by a separation wall provided with one or more openings wherein an outlet is provided at the outermost additional compartment.

### CROSS-REFERENCE TO RELATED APPLICATIONS

This application is a continuation under 35 U.S.C. 111 of International Patent Application No. PCT/DK2024/050009, filed Jan. 23, 2024, which claims the benefit of and priority to Danish Application No. PA 2023 00067, filed Jan. 25, 2023, each of which is hereby incorporated by reference in its entirety.

### FIELD OF INVENTION

The present invention relates to non-biological wastewater treatment systems that are suitable as on-site non-sewered sanitation solutions for residential homes to ensure that all household wastewater is properly treated to make it safe, clean, and suitable for releasing back into a water body as well as for re-use within non-potable residential purposes. The present invention also relates to methods for treating wastewater using a non-biological wastewater treatment system according to the present disclosure.

### BACKGROUND

Today, most wastewater is collected through large sewer systems for treatment at a large central wastewater treatment plant.

Sewer systems are inflexible, very expensive and time consuming to expand and maintain. Investment demand is worldwide; therefore, increasing far faster than any economy due to factors like climate change, growing population, urbanization and rising environmental standards. Therefore, the sector is on the verge of a transformation into more advanced and decentralized solutions that shall bring more sustainability, lower cost, and faster implementation.

Decentralized on-site treatment solutions for residential homes have existed for many years, although all biology-based. These systems are characterized by mainly removing organics, nitrogen and phosphorous, but the effluent still contains harmful bacteria, viruses, and pathogens, as well as micropollutants and other hazardous substances, so risk to human health and the water environment remain. Biology-based systems are, due to their nature, vulnerable to load variations, periods without load and discharge of substances and chemicals that inhibits the biological processes. Restoring performance may extend over weeks and can only be verified by sampling and lab work. Biological treatment (aerobic) also degrades the biomethane-potential by turning a large fraction of the organics into carbon dioxide. All-in-all, these biology-based systems are not addressing the need for more sustainability (i.e. better treatment for all substances, higher valorization of the valuables in the wastewater and water re-use) and fail in enabling an effective operation and performance monitoring of many small systems due to their biological nature.

Reverse osmosis membrane technologies are known and have been widely used for many years, especially for drinking water applications and industrially for very pure water production. Forward osmosis membrane technologies, that rely on natural osmosis principles to drag water through the membrane using salt-water solutions, have also been known for many years but are only rarely used and then mainly for industrial purposes as the draw salt solution handling is considered an unwanted complexity. Overall, membranes are not considered suitable for treatment of raw wastewater, as this normally requires extensive pre-treatment and energy intensive anti fouling to work without clogging.

The prior art non-biological wastewater treatment systems require several pretreatment steps in order to avoid the non-biological wastewater treatment processes being interrupted on a daily or weekly basis for carrying out a required cleaning process.

EP3865204A1 discloses a non-biological wastewater treatment system and method of treatment of wastewater. The method recovers draw agent utilized in a forward osmosis membrane cell. The method comprises the steps of passing diluted draw agent to a vapor-liquid separator; using the vapor-liquid separator to separate draw agent vapor and solvent and condensing draw agent vapor. The process, however, requires a pretreatment step in order to carry out the method. Therefore, it would be advantageous to be able to provide an alternative method.

### BRIEF DESCRIPTION

It is an objective of the present systems and methods to create a better alternative to the prior art biology-based solutions by addressing those problems related to making membrane technologies like forward osmosis and reverse osmosis work on raw wastewater without biological processes.

It is an objective of the present systems and methods to create non-biological wastewater treatment systems that do not require any pretreatment processing steps.

A wastewater treatment system according to the present disclosure is a non-biological wastewater treatment system comprising a water extraction unit having a forward osmosis water extraction unit and a draw recovery system that is connected to and configured to receive a diluted draw solution from the forward osmosis water extraction unit, wherein the non-biological wastewater treatment system comprises a phase separation and clarification tank, wherein the phase separation and clarification tank comprises an inlet configured to receive wastewater to be treated by the wastewater treatment system, wherein the phase separation and clarification tank has a wet volume, wherein the inlet is connected to a first compartment,
wherein the volume of the phase separation and clarification tank is selected in dependency of a predefined operation period and an expected wastewater production to be received by the wastewater treatment system in such a manner that the non-biological wastewater treatment system is configured to be operated without removing sludge from a bottom layer of the phase separation and clarification tank for the predefined operation period;
selecting a predefined percentage of the mass fraction of particles that should be settled in the phase separation and clarification tank;
determining a settling velocity at which the selected percentage of particles does settle;
dimensioning the phase separation and clarification tank in a manner in which after the predefined operation period:
a) the retention time is at least 2 hours; and
b) the settling velocity is so low that the predefined percentage of the mass fraction of particles will settle in the phase separation and clarification tank.

Hereby, it is possible to provide a better alternative to the prior art biology-based solutions. It is possible to provide a non-biological wastewater treatment system that is compact, inexpensive and requires only a limited amount of manual service and thus is suitable for domestic use. It is also possible to provide a non-biological wastewater treatment system that does not require any pretreatment processing steps.

The settling velocity is the vertical velocity.

By using a non-biological wastewater treatment system, it is possible to avoid the disadvantages associated with the use of biological wastewater treatment systems.

The wastewater treatment system comprises a water extraction unit having a forward osmosis water extraction unit and a draw recovery system that is connected to and configured to receive a diluted draw solution from the forward osmosis water extraction unit.

In an embodiment, the forward osmosis water extraction unit comprises a single forward osmosis membrane.

In an embodiment, the forward osmosis water extraction unit comprises several forward osmosis membranes. In an embodiment, the forward osmosis membranes are arranged in a single housing. In an embodiment, the forward osmosis membranes are arranged in several housings. In an embodiment, each forward osmosis membrane is arranged in its own housing. In an embodiment, the forward osmosis membranes are provided without an external housing.

In an embodiment, the wastewater treatment system is configured to ensure that the flow of the wastewater through the phase separation and clarification tank causes the retention time of the wastewater to be at least 12 hours in the phase separation and clarification tank.

The non-biological wastewater treatment system comprises a phase separation and clarification tank. The tank is configured to ensure that the water entering the water extraction unit is pretreated to such an extent that the water extraction unit can filter the water received from the tank for long periods of time without plugging. The phase separation and clarification tank is arranged and configured to only transfer a fraction of the wastewater, wherein said fraction comprises none or only an extremely small concentration of settleable solids. Accordingly, since the water extraction unit receives only wastewater comprising none or only an extremely small concentration of settleable solids, the water extraction unit can filter the wastewater for long periods of time without clogging.

The phase separation and clarification tank comprises an inlet connected to a first compartment and one or more additional compartments. The phase separation and clarification tank comprises an inlet, through which wastewater enters the tank. The inlet is typically designed as an inlet pipe.

Each compartment is separated from adjacent compartments, by a separation wall provided with one or more openings.

In an embodiment, the clarification tank comprises one or more additional compartments, wherein the first compartment is in fluid communication with the one or more additional compartments.

In an embodiment, the clarification tank comprises one or more additional compartments, wherein each compartment is separated from adjacent compartments, by a separation wall provided with one or more openings.

In an embodiment, the water extraction unit is arranged and configured to receive wastewater from the outermost additional compartment.

In an embodiment, the phase separation and clarification tank comprises a water level provided at a water level height, wherein the clarified layer of the phase separation and clarification tank is provided at a level corresponding to 10-90% of the water level height above the bottom of the phase separation and clarification tank.

In an embodiment, each compartment is separated from adjacent compartments by a separation wall provided with a single opening.

In an embodiment, the tank comprises an outlet provided at the outermost additional compartment. Hereby, wastewater can enter the first compartment and flow through the remaining one or more compartments of the phase separation and clarification tank and eventually leave the tank when leaving the outermost additional compartment.

In an embodiment, the phase separation and clarification tank comprises a water level provided at a water level height, wherein the outlet is provided at a level corresponding to 10-90% of the water level height above the bottom of the phase separation and clarification tank.

The outlet is provided at a level corresponding to 10-90% of the water level height of the phase separation and clarification tank above the bottom of the phase separation and clarification tank.

In an embodiment, an outlet is provided at the outermost additional compartment.

In an embodiment, the outlet is provided at a level corresponding to 20-80% of the water level height of the phase separation and clarification tank above the bottom of the phase separation and clarification tank.

In an embodiment, the outlet is provided at a level corresponding to 30-70% of the water level height of the phase separation and clarification tank above the bottom of the phase separation and clarification tank.

In an embodiment, the flow of the wastewater through the phase separation and clarification tank causes the retention time of the wastewater to be at least 24 hours.

In an embodiment, the flow of the wastewater through the phase separation and clarification tank causes the retention time of the wastewater to be at least 36 hours.

In an embodiment, the flow of the wastewater through the phase separation and clarification tank causes the retention time of the wastewater to be in the range 24-48 hours.

In an embodiment, the wastewater in the first compartment and the one or more additional compartments comprises a water level that is maintained within a fixed predefined range so that the fluctuation of the water level is less than 10% of the wet volume of the phase separation and clarification tank.

In an embodiment, the wastewater in the first compartment and the one or more additional compartments comprises a water level that is maintained within a fixed predefined range so that the fluctuation of the water level is less than 5% of the wet volume of the phase separation and clarification tank.

In an embodiment, the wastewater treatment system comprises a buffer tank that is arranged and configured to receive wastewater from an outlet structure of the phase separation and clarification tank.

In an embodiment, the buffer tank is connected to the outermost additional compartment of the phase separation and clarification tank via an outlet pipe.

In an embodiment, the buffer tank is connected to a pump arranged and configured to pump wastewater towards the water extraction unit.

In an embodiment, the buffer tank comprises a water level sensor arranged to detect the water level height inside the buffer tank.

In an embodiment, the water level sensor is connected to the pump, wherein the pump is configured to be operated in dependency of detections made by the water level sensor.

Each compartment is arranged and configured to facilitate a gravity induced separation step, during which the settleable solids from the wastewater settle into the bottom layer (sludge layer) of the compartment. Particles in the wastewater will form heavier particles that will settle by gravity under the quiescent conditions that are present in the compartment. At the same time, any grease and scum will float to the top layer (floating layer) near the surface of the compartment.

In an embodiment, the one or more forward osmosis membranes are hollow fiber membranes forward osmosis membranes.

In an embodiment, the one or more forward osmosis membranes are flat sheet forward osmosis membranes.

In an embodiment, a buffer tank connected to the water extraction unit comprises:
a water level sensor arranged and configured to detect the buffer tank water level; and
a pump,
   wherein the pump and the water extraction unit are arranged and configured to maintain the buffer tank water level within a predefined upper level and a predefined lower range, wherein the fluctuation of the buffer tank water level is less than 50% of the wet volume of the buffer tank.

Hereby, the buffer tank makes it possible to level out incoming flow variations and operate the water extraction unit at a lower fixed rate.

In an embodiment, the fluctuation of the buffer tank water level is less than 33% of the wet volume of the buffer tank.

In an embodiment, the fluctuation of the buffer tank water level is less than 20% of the wet volume of the buffer tank.

In an embodiment, the fluctuation of the buffer tank water level is less than 10% of the wet volume of the buffer tank.

In an embodiment, the buffer tank is integrated in the outermost additional compartment, wherein the water extraction unit is configured to maintain the buffer tank water level within a predefined upper level and a predefined lower range, wherein a circulation pump is arranged in the buffer tank, wherein the circulation pump is arranged and configured to pump wastewater from the buffer tank to the first compartment via a guide structure.

In an embodiment, the buffer tank is integrated in the phase separation and clarification tank, wherein the water extraction unit is configured to maintain the buffer tank water level within a predefined upper level and a predefined lower range, wherein a circulation pump is arranged in the buffer tank, wherein the circulation pump is arranged and configured to pump wastewater from the buffer tank to the first compartment via a guide structure.

In an embodiment, the guide structure is a pipe.

In an embodiment, the water extraction unit is arranged and configured to guide permeate water out of the buffer tank.

In an embodiment, the draw recovery system is formed as a reverse osmosis water extraction unit.

In an embodiment, the tank comprises a single additional compartment only, wherein the volume of the first compartment constitutes 70-90% of the total volume of the phase separation and clarification tank.

In an embodiment, the tank comprises two additional compartments only, wherein the volume of the first compartment constitutes 50-70% of the total volume of the phase separation and clarification tank, wherein the ratio between the volume of the first additional compartment and the second additional compartment is in the range 0.7-1.30.

In an embodiment, the ratio between the total surface area of the compartments and the total volume of the compartments is in the range 0.6-0.9 m²/m³.

In an embodiment, the total area of the one or more openings is equal to or larger than the cross-sectional area of the inlet.

In an embodiment, the inlet is formed as a pipe having a cross-sectional area.

In an embodiment, the openings are arranged in positions in which the distance between the water level of the tank and the uppermost portion of the openings is at least 0.20 m.

In an embodiment, the one or more openings are arranged in positions in which the distance between the water level of the phase separation and clarification tank and the uppermost portion of the openings is at least 0.25 m.

In an embodiment, the openings are arranged in positions in which the distance between the water level of the tank and the uppermost portion of the openings is at least 0.30 m.

It may be an advantage to arrange the opening such that the transport distance of the wastewater flowing through the tank is maximized.

In an embodiment, the cross-sectional area of the outlet is equal to or larger than the area of the inlet.

In an embodiment, the forward osmosis water extraction unit and the draw recovery system are connected directly via a fluid line and via an open container containing water that contains a concentration of dissolved salt, wherein the container is arranged and configured to provide ventilation that removes air above the water in the container and introduces atmospheric air into the area above the water in the container, wherein the ventilation is provided by:
a) brine from the draw recovery system, wherein the brine leaves the draw recovery system via a fluid line, wherein the fluid line is connected to and guides the brine to the open container, wherein the brine is released from a distal end of the fluid line and falls into the water in the container; or
b) a ventilation assembly arranged and configured to ventilate a water surface of the container.

Accordingly, the forward osmosis water extraction unit will automatically adjust to the same liquid flow as permeate is drawn from the reverse osmosis water extraction unit. With increasing resistance across the membrane(s) of the forward osmosis water extraction unit, the water level in the container will drop until the concentration becomes so high that the balance is restored. Moreover, if the water level in the container is below a predefined lower level, it indicates that an additional amount of salt has to be filled into the container.

The ventilation assembly may comprise any suitable type of ventilator and optionally a mechanical device arranged and configured to provide a sufficiently large degree of turbulence to draw hydrogen sulfide (H₂S) out of the water in the container into the air phase of the container.

By the term “salt water” is meant water that contains a high concentration of dissolved salt such as sodium chloride (NaCl), magnesium chloride (MgCl₂), sodium bicarbonate (NaHCO₃) or other substances (e.g. salts or a sugar solution) suitable for use in the forward osmosis water extraction unit.

In an embodiment, the flow of the brine released from a distal end of the fluid line is at least one time the flow of the fluid in the outlet line. In an embodiment, the flow of the brine released from a distal end of the fluid line is higher or equal to two times the flow of the fluid in the outlet line. In an embodiment, the flow of the brine released from a distal end of the fluid line is at least three times the flow of the fluid in the outlet line.

In an embodiment, the container is provided with a mixer arranged and configured to provide a sufficiently large degree of turbulence to draw hydrogen sulfide (H₂S) out of the water in the container into the air phase of the container.

In an embodiment, the container is provided with a fan arranged and configured to ventilate the water surface of the container. Hereby, the fan will provide the required ventilation and hereby ensure that the air phase can take up hydrogen sulfide (H₂S) in an efficient manner.

In an embodiment, the wastewater treatment system is configured to ensure that concentrate from the forward osmosis water extraction unit flows to the first compartment via one or more lines.

In an embodiment, a pump is arranged and configured to suck diluted draw solution from the forward osmosis water extraction unit and pump the draw solution through the draw recovery system (being a reverse osmosis water extraction unit).

In an embodiment, a pump is arranged and configured to suck diluted draw solution from the forward osmosis water extraction unit and pump the draw solution through the draw recovery system (being a reverse osmosis water extraction unit), wherein the pump is combined with a pressure relief valve arranged at the outlet from the reverse osmosis water extraction unit. The pressure relief valve should be arranged before the open container.

In an embodiment, the pump is arranged and configured to pressure liquid and to recover pressure energy. Hereby, the pressure in the water flow at the outlet of the reverse osmosis water extraction unit helps to produce the required pressure and flow at the inlet. Accordingly, less energy is required to drive the reverse osmosis water extraction unit.

In an embodiment, the ratio between permeate flow and feed flow (recovery rate) of the reverse osmosis water extraction unit is fixed. This is possible because the pressure recovery unit is constructed such that there is a fixed ratio between the permeate flow and the feed flow. Hereby, it is possible to simplify the construction of the entire system because no control unit comprising a flow meter and an actuator for the pressure relief valve that keeps the permeate flow constant at changing pressure/salt concentrations is required.

In an embodiment, a valve is arranged between the open container and the forward osmosis water extraction unit. Hereby, the valve can prevent new salt water from being supplied to the forward osmosis water extraction unit during the stop process.

In an embodiment, the forward osmosis water extraction unit is arranged vertically such that the one or more forward osmosis membranes of the forward osmosis water extraction unit extends vertically. Hereby, draining the membranes (e.g. in order to remove fouling) is eased.

A method according to the present disclosure is a method for treating wastewater by using a non-biological wastewater treatment system comprising a water extraction unit having a forward osmosis water extraction unit and a draw recovery system that is connected to and configured to receive a diluted draw solution from the forward osmosis water extraction unit, wherein the method comprises the step of applying a phase separation and clarification tank, wherein the tank comprises an inlet configured to receive wastewater to be treated by the wastewater treatment system, wherein the phase separation and clarification tank has a wet volume, wherein the inlet is connected to a first compartment, wherein the method comprises:
selecting a predefined operation period and designing the volume of the phase separation and clarification tank of the non-biological wastewater treatment system in dependency of an expected wastewater production to be received by the wastewater treatment system such that the non-biological wastewater treatment system can be operated without removing sludge from a bottom layer of the phase separation and clarification tank for the predefined operation period;
selecting a predefined percentage of the mass fraction of particles that should be settled in the phase separation and clarification tank;
determining a settling velocity at which the selected percentage of particles does settle;
dimensioning the phase separation and clarification tank in a manner in which after the predefined operation period:
a) the retention time is at least 2 hours; and
b) the settling velocity is so low that the predefined percentage of the mass fraction of particles will settle in the phase separation and clarification tank.

Hereby, it is possible to provide an alternative method for treating wastewater. The method requires a less space-consuming system, that is inexpensive (compared to the prior art methods) and requires only a limited amount of manual service and thus is suitable for domestic use.

In an embodiment, the expected wastewater production is an expected average 24-hour wastewater production (Q_{average}).

In an embodiment, the predefined percentage (Pₚᵣₑ) of the mass fraction of particles that should be settled in the phase separation and clarification tank is 90%.

In an embodiment, the predefined percentage (Pₚᵣₑ) of the mass fraction of particles that should be settled in the phase separation and clarification tank is at least 80%.

In an embodiment, the predefined percentage (Pₚᵣₑ) of the mass fraction of particles that should be settled in the phase separation and clarification tank is at least 75%.

In an embodiment, the predefined operation period is one year. In an embodiment, the predefined operation period is 6 months. In an embodiment, the predefined operation period is 3 months. In an embodiment, the predefined operation period is 2 months. In an embodiment, the predefined operation period is 1 month.

In an embodiment, the method comprises the step of ensuring that the flow of the wastewater through the phase separation and clarification tank causes the retention time of the wastewater to be at least 12 hours in the phase separation and clarification tank.

In an embodiment, the flow of the wastewater through the phase separation and clarification tank causes the retention time of the wastewater to be at least 24 hours.

In an embodiment, the flow of the wastewater through the phase separation and clarification tank causes the retention time of the wastewater to be in the range 24-36 hours.

In an embodiment, the phase separation and clarification tank comprises one or more additional compartments, wherein each compartment is separated from adjacent compartments by a separation wall provided with one or more openings.

In an embodiment, the outlet is provided at a level corresponding to 10-90% of the water level height above the bottom of the phase separation and clarification tank.

In an embodiment, the wastewater treatment system comprises a buffer tank that is connected to the outlet and to the water extraction unit, wherein the method comprises the steps of:
detecting the buffer tank water level; and
maintaining the buffer tank water level within a predefined upper level and a predefined lower level.

In an embodiment, the difference between the predefined upper level and the predefined lower level is selected in dependency of the average 24-hour wastewater production (received by the wastewater treatment system).

In an embodiment, the difference between the predefined upper level and the predefined lower level corresponds to 0.3-2.0 times the average 24-hour wastewater production (received by the wastewater treatment system).

In an embodiment, the difference between the predefined upper level and the predefined lower level corresponds to 0.5-1.7 times the average 24-hour wastewater production (received by the wastewater treatment system).

In an embodiment, the difference between the predefined upper level and the predefined lower level corresponds to 1-1.5 times the average 24-hour wastewater production (received by the wastewater treatment system).

In an embodiment, the draw recovery system is formed as a reverse osmosis water extraction unit.

In an embodiment, the tank comprises a single additional compartment only, wherein the volume of the first compartment constitutes 70-90% of the total volume of the tank.

In an embodiment, the tank comprises two additional compartments, wherein the volume of the first compartment constitutes 50-70% of the total volume of the tank, wherein the ratio between the volume of the first compartment and the second compartment is in the range 0.7-1.30.

In an embodiment, the ratio between the total surface area of the compartments and the total volume of the compartments is in the range 0.6-0.9 m²/m³.

In an embodiment, the total area of the openings is equal to or larger than the cross-sectional area of the inlet.

In an embodiment, the water extraction unit comprises an open container arranged and configured to receive brine from the forward osmosis water extraction unit.

In an embodiment, the method comprises a backwash procedure in which a recirculation pump arranged and configured to suck permeate from the open container through the forward osmosis water extraction unit and the draw recovery system is stopped when the permeate from the open container has reached an outlet of the draw recovery system.

Hereby, the osmotic pressure difference across the membrane(s) of the forward osmosis water extraction unit reverses, so that water from the draw side of the forward osmosis water extraction unit is driven towards the feed side of the forward osmosis water extraction unit. Hereby, an osmotic backwash effect is achieved.

The osmotic pressure difference across the membrane(s) of the reverse osmosis water extraction unit is equalized to nearly zero. Hereby, the concentrations of contaminants on the permeate side of the reverse osmosis water extraction unit do not change during the following period in which the pump is shut off (otherwise the concentrations of contaminants on the permeate side of the reverse osmosis water extraction unit could increase).

By sending permeate water through a permeate fluid line and outlet line, the draw circuit is not contaminated.

In an embodiment, the backwash procedure is kept running for a predefined time period to allow the osmotic pressure difference across the membrane(s) of the reverse osmosis water extraction unit to be equalized to a level that is equal to or less than a predefined level (close to zero).

In an embodiment, the predefined pressure difference is less than 10% of the operating pressure of the reverse osmosis water extraction unit.

In an embodiment, the predefined pressure difference is less than 5% of the operating pressure of the reverse osmosis water extraction unit.

In an embodiment, the predefined pressure difference is less than 2% of the operating pressure of the reverse osmosis water extraction unit.

In an embodiment, the predefined pressure difference is less than 1% of the operating pressure of the reverse osmosis water extraction unit.

In an embodiment, the predefined pressure difference is less than 0.5% of the operating pressure of the reverse osmosis water extraction unit.

In an embodiment, the flux (e.g. the hourly flow through the surface area) of the one or more membranes of the reverse osmosis water extraction unit is in the range 0.05-0.5.

In an embodiment, the predefined time period is 40 minutes.

In an embodiment, the predefined time period is 30 minutes.

In an embodiment, the predefined time period is 25 minutes.

In an embodiment, the predefined time period is 20 minutes.

In an embodiment, the predefined time period is 15 minutes.

The backwash will cause some of the membrane fouling to come loose. Hereby, the backwash positively contributes to keeping the membrane clean.

In an embodiment, the water extraction unit comprises an open container arranged and configured to receive permeate water from the reverse osmosis water extraction unit, wherein wastewater is drained out of the feed side of the forward osmosis water extraction unit while the forward osmosis water extraction unit is subsequently filled with permeate water from a first part of the container.

In an embodiment, the water extraction unit comprises an open container arranged and configured to receive permeate water from the reverse osmosis water extraction unit, wherein wastewater is displaced from the feed side of the forward osmosis water extraction unit. The forward osmosis water extraction unit may subsequently be filled with permeate water from a first part of the container.

In an embodiment, at regular intervals or when the wastewater treatment system is down for a long time, this may be combined with addition of biocide into the container.

By carrying out this drainage, particles and fouling that has come loose are removed from the membrane(s) of the forward osmosis water extraction unit. In the subsequent relaxation of the membrane(s) of the forward osmosis water extraction unit, less fouling occurs. This will contribute to keeping fouling of the membrane(s) of the forward osmosis water extraction unit under control. Biocide will ensure against biofilm growth inside the membrane(s) of the forward osmosis water extraction unit. By applying these method steps, it is possible to keep the wastewater treatment system ready to be started and operated stably over a long period of time.

By using permeate water, salt is not returned to the feed side of the forward osmosis water extraction unit (and thus to the tank). After carrying out said method steps, the wastewater treatment system is ready to start again and/or to standby for a longer period of time.

In an embodiment, the method applies a buffer tank that is integrated in the outermost additional compartment, wherein the water extraction unit is configured to maintain the buffer tank water level within a predefined upper level and a predefined lower range, wherein a circulation pump is arranged in the buffer tank, wherein the circulation pump is arranged and configured to pump wastewater from the buffer tank to the first compartment via a guide structure.

In an embodiment, the water extraction unit is arranged and configured to guide permeate water out of the buffer tank.

In an embodiment, the method comprises the step of applying a wastewater treatment system according to the present disclosure.

### BRIEF DESCRIPTION OF THE DRAWINGS

The systems and methods will become more fully understood from the detailed description given herein below. The accompanying drawings are given by way of illustration only, and thus, they are not limitative. In the accompanying drawings:

FIG. 1A shows a schematic cross-sectional view of a non-biological wastewater treatment system according to an embodiment;

FIG. 1B shows a schematic cross-sectional view of another non-biological wastewater treatment system according to an embodiment;

FIG. 2A shows a schematic cross-sectional view of another non-biological wastewater treatment system according to an embodiment;

FIG. 2B shows a schematic cross-sectional view of another non-biological wastewater treatment system according to an embodiment;

FIG. 3A shows a schematic cross-sectional view of a further non-biological wastewater treatment system according to an embodiment;

FIG. 3B shows a schematic cross-sectional view of another non-biological wastewater treatment system according to an embodiment;

FIG. 4 shows a schematic view of a water extraction unit of a non-biological wastewater treatment system according to an embodiment;

FIG. 5 shows a schematic view of a water extraction unit of a non-biological wastewater treatment system according to an embodiment;

FIG. 6A shows a cross-sectional view of a tank of a wastewater treatment system according to an embodiment;

FIG. 6B shows a cross-sectional view of a tank of a wastewater treatment system according to an embodiment;

FIG. 6C shows a cross-sectional view of a tank of a wastewater treatment system according to an embodiment;

FIG. 6D shows a cross-sectional view of a tank of a wastewater treatment system according to an embodiment;

FIG. 7A shows a schematic cross-sectional view of a non-biological wastewater treatment system according to an embodiment;

FIG. 7B shows a schematic cross-sectional view of a further non-biological wastewater treatment system according to an embodiment;

FIG. 8A shows a schematic cross-sectional view of a non-biological wastewater treatment system according to an embodiment;

FIG. 8B shows a schematic cross-sectional view of another non-biological wastewater treatment system according to an embodiment;

FIG. 9A shows a graph depicting the mass fraction (%) of particles as a function of the settling velocity (VS);

FIG. 9B shows a graph depicting the settled mass of the total suspended solids (TSS) as a function of the settling time;

FIG. 10A shows a schematic cross-sectional view of a non-biological wastewater treatment system according to an embodiment; and

FIG. 10B shows the non-biological wastewater treatment system shown in FIG. 10A in a state at which sludge in the phase separation and clarification tank needs to be removed.

### DETAILED DESCRIPTION

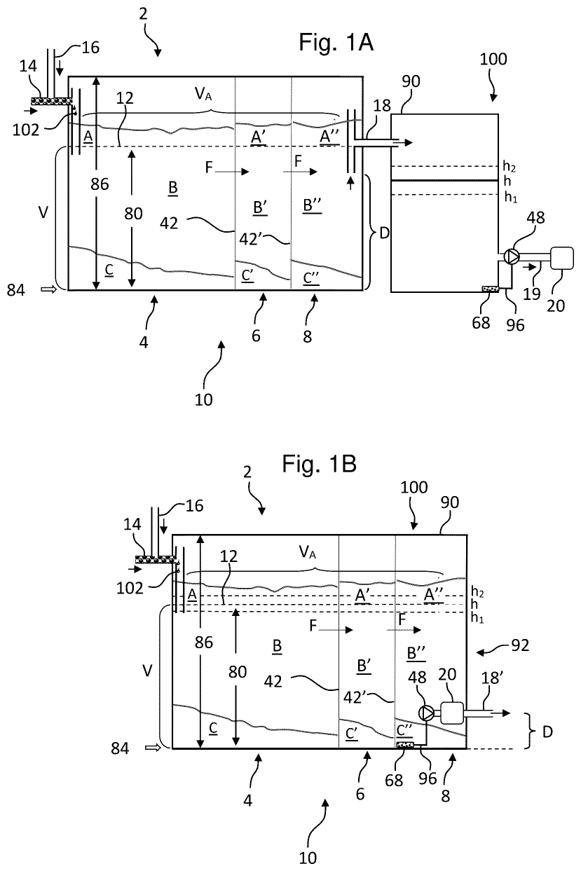

Referring now in detail to the drawings for the purpose of illustrating embodiments of the present systems and methods, a non-biological wastewater treatment system 2 is illustrated in FIG. 1A.

FIG. 1A illustrates a schematic cross-sectional view of a non-biological wastewater treatment system 2 according to an embodiment. The wastewater treatment system 2 comprises a phase separation and clarification tank 10 configured to receive and contain wastewater 102. The phase separation and clarification tank 10 comprises a first compartment 4, a second compartment 6 and a third compartment 8.

In an embodiment, the volume of the first compartment 4 corresponds to 50-70% of the total volume of the phase separation and clarification tank 10, while a volume of the second compartment 6 basically corresponds to the volume of the third compartment 8.

Wastewater 102 enters the phase separation and clarification tank 10 through an inlet pipe 14 that is connected to the upper part of the first compartment 4. Hereafter a gravity separation step is initiated. During this step, the settleable solids from the wastewater 102 will settle into the bottom layer (sludge layer) C of the first compartment 4. Particles in the wastewater 102 will form heavier particles that will settle by gravity under the quiescent conditions that are present in the first compartment 4. At the same time, any grease and scum will float to the top layer A (floating layer) near the surface of the first compartment 4.

The first compartment 4 comprises a clarification layer B of fluid containing water and components having a density close to the density of water. Components having a higher density than water will settle at the bottom layer C. Components having a lower density than water will float and thus be present at the top layer A.

The first compartment 4 is separated from the second compartment 6 by a separation wall 42 that is provided with one or more openings or slots. In an embodiment, the separation wall 42 is formed as a perforated plate. In an embodiment, the separation wall 42 comprises a section formed as a perforated plate. In an embodiment, the separation wall 42 comprises a single opening only.

The second compartment 6 is separated from the third compartment 8 by a separation wall 42′ comprising one or more openings or slots. In an embodiment, the separation wall 42′ is formed as a perforated plate. In an embodiment, the separation wall 42′ comprises a section formed as a perforated plate. In an embodiment, the separation wall 42′ comprises a single opening only.

The second compartment 6 comprises a bottom layer (sludge layer) C′, a top layer A′ (floating layer) located near the surface of the second compartment 6. The second compartment 6 comprises a clarification layer B′ of fluid containing water and components having a density close to the density of water.

A flow F of fluid is flowing from the first compartment 4 to the second compartment 6 through the first separation wall 42. The same flow F is flowing from the second compartment 6 to the third compartment 8 through the second separation wall 42′.

Settled solids in the bottom layers C, C′, C″ of the tank 10 and floatable solids of the top layers A, A′, A″ of the phase separation and clarification tank 10 are kept in the phase separation and clarification tank 10 for a long period (in one embodiment, one year). Accordingly, the size of the phase separation and clarification tank 10 needs to be selected in dependency of the quantity of wastewater entering into the phase separation and clarification tank 10.

The clarified effluent from the clarification layer B″ of the third compartment 8 is conveyed via an overflow pipe 18 to a buffer tank 90. The overflow pipe 18 comprises a horizontal portion extending from a vertical portion that determines the water level 12 in the phase separation and clarification tank 10. A part of the vertical portion extends above the water level 12 of the phase separation and clarification tank 10.

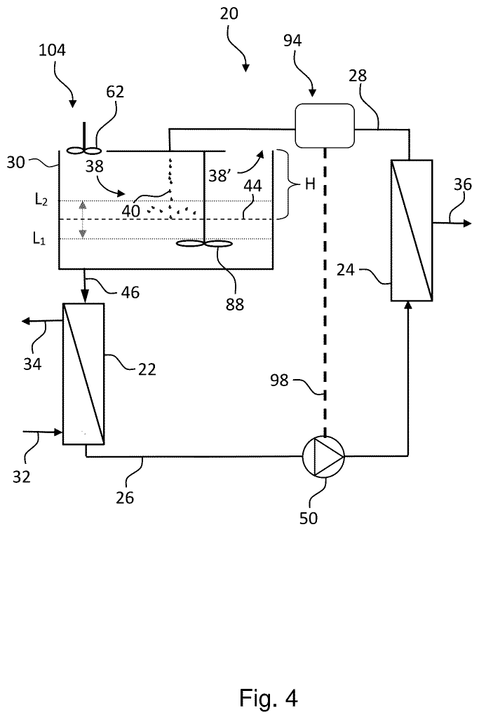

From the buffer tank 90, the water is guided towards a water extraction unit 20, for further treatment, via an outlet pipe 19. A pump 48 may be arranged between the buffer tank 90 and the water extraction unit 20. An example of a water extraction unit 20 is shown and explained with reference to FIG. 4.

The wastewater treatment system 2 comprises a control system 100 configured to control the pump 48 and the water extraction unit 20 in order to keep the water level h in the buffer tank 90 between h₁ and h₂. A water level sensor 68 is provided in the buffer tank 90. The water level sensor 68 is arranged and configured to determine the water level h in the buffer tank 90. The water level sensor 68 may be arranged at the bottom of the buffer tank 90. In another embodiment, the water level sensor 68 may be replaced by another type of water level sensor that may be arranged in another position.

In an embodiment, the water level sensor 68 is communicatively connected to the pump 48 and the water extraction unit 20. Accordingly, the flow through the outlet pipe 19 can be regulated by controlling the activity of the pump 48 and the water extraction unit 20 on the basis of measurements made by the water level sensor 68. In an embodiment, the wastewater treatment system 2 comprises a control unit that is communicatively connected to the water level sensor 68 and the pump 48.

In an embodiment, the water level sensor 68 is electrically connected to the pump 48 by a wire 96.

In an embodiment, the wastewater treatment system 2 is configured to regulate the flow through outlet pipe 19 by:
a) activating the pump 48 when the water level in the buffer tank 90 equals a predefined upper water level h₂; and
b) deactivating the pump 48 when the water level equals a predefined lower water level h₁.

Hereby, it is possible to maintain the water level 12 in the phase separation and clarification tank 10 within a predefined range in which the fluctuation of the water level 12 is less than 50% of the wet volume V of the phase separation and clarification tank 10. In an embodiment, the water level 12 in the phase separation and clarification tank 10 is maintained within a predefined range in which the fluctuation of the water level 12 is less than 33% of the wet volume V of the phase separation and clarification tank 10. In an embodiment, the water level 12 in the phase separation and clarification tank 10 is maintained within a predefined range in which the fluctuation of the water level 12 is less than 20% of the wet volume V of the phase separation and clarification tank 10.

Concentrate from the water extraction unit 20 may enter the phase separation and clarification tank 10 through an additional pipe 16. An additional pipe 16 is connected to the inlet pipe 14. In another embodiment, however, the additional pipe 16 is connected directly to the upper part of the first compartment 4.

The total volume of the phase separation and clarification tank 10 should fit to the quantity of wastewater flowing into the phase separation and clarification tank 10.

In an embodiment, the non-biological wastewater treatment system 2 according to an embodiment is designed as a domestic wastewater treatment system. Such wastewater treatment system 2 must ensure that all household sewage is properly treated to make it safe, clean, and suitable for releasing back into the environment, lakes, or streams. Such domestic wastewater treatment system is designed to treat all of the liquid waste generated from a residence.

In an embodiment, the total volume of the top layers A, A′, A″ is designed to allow collection of any grease and scum floating to the top layers A, A′, A″ during a period of one year.

In an embodiment, the total volume of the top layers A, A′, A″ is selected and designed to allow collection of 60 liter for each person in the household (this will typically correspond to the production for one year). Accordingly, the total volume V_{A} of the top layers A, A′, A′ in a household with N persons is defined by the following equation:

V_{A}=N*60 liters (1)

In a typical household having four persons, the total volume V_{A} of the top layers A, A′, A″ will be 240 liters.

To total volume V_{B} of the clarification layers B, B′, B″ should be designed to contain a volume corresponding to about 24-48 hours production of wastewater. Accordingly, the wastewater would have a retention time of 24-48 hours. The production of wastewater is typically 150 liter per day for each person in the household.

In an embodiment, the total volume of the bottom layers C, C′, C″ is selected and designed to allow collection of settled solids during a period of one year.

In an embodiment, the total volume of the bottom layers C, C′, C″ is designed to allow collection of 180 liter for each person in the household (this will typically correspond to the production for one year). Accordingly, the total volume V_{B} of the bottom layers C, C′, C″ in a household with N persons is defined by the following equation:

V_{B}=N*180 liters (2)

In a typical household having four persons, the total volume V_{B} of the bottom layers C, C′, C″ will be 720 liters.

In a household comprising N persons the total wet volume V of the phase separation and clarification tank 10 is in the range: N*(60 liters+150 liters+180 liters) to N*(60 liters+300 liters+180 liters) equaling N times 390 liters to N times 540 liters.

### Example 1

In a five persons household, the total wet volume V of the phase separation and clarification tank 10 is in the range: 5 times 390 liter to 5 times 540 liter which is 1950 liters to 2700 liters.

In an embodiment, the ratio between the total surface area of the top layers A, A′, A″ of the phase separation and clarification tank 10 and the total wet volume V of the phase separation and clarification tank 10 is in the range 0.3-1.2.

In an embodiment, the ratio between the total surface area of the top layers A, A′, A″ of the phase separation and clarification tank 10 and the total wet volume V of the phase separation and clarification tank 10 is in the range 0.5-1.0.

In an embodiment, the ratio between the total surface area of the top layers A, A′, A″ of the phase separation and clarification tank 10 and the total wet volume V of the phase separation and clarification tank 10 is in the range 0.6-0.9.

FIG. 1B illustrates a schematic cross-sectional view of another non-biological wastewater treatment system 2 according to an embodiment. The wastewater treatment system 2 basically corresponds to the one shown in and explained with reference to FIG. 1A. The second additional compartment 8, the buffer tank 90, the pump 48 and the water extraction unit 20, however, are integrated in a tank assembly 92.

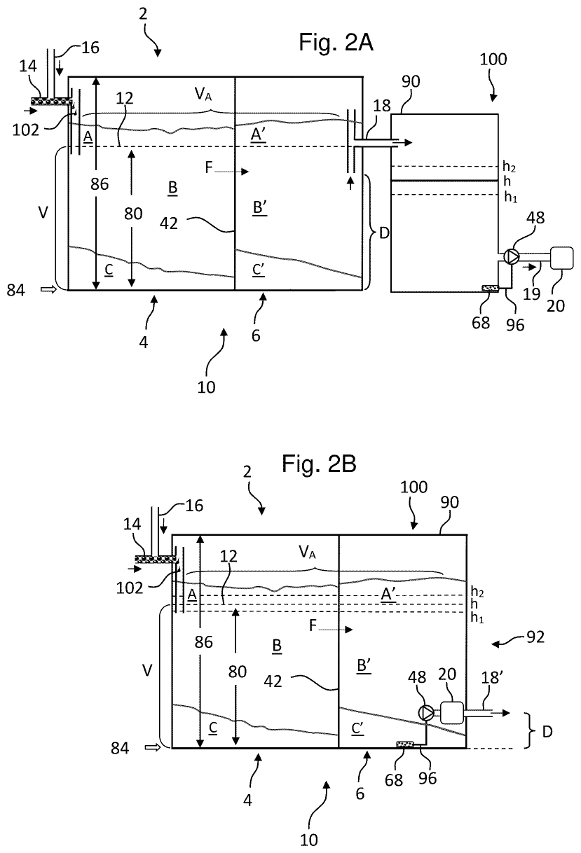

FIG. 2A illustrates a schematic cross-sectional view of another non-biological wastewater treatment system 2 according to an embodiment. The wastewater treatment system 2 basically corresponds to the one shown in FIG. 1A. The wastewater treatment system 2, however, instead of three compartments, the phase separation and clarification tank 10 comprises only two compartments: a first compartment 4 and a second compartment 6.

In an embodiment, the volume of the first compartment 4 corresponds to 70-90% of the total wet volume of the phase separation and clarification tank 10, while the volume of the second compartment 6 corresponds to the remaining volume (10-30%) of the phase separation and clarification tank 10.

Wastewater enters the phase separation and clarification tank 10 through an inlet pipe 14 that is connected to the upper part of the first compartment 4. Hereafter the settleable solids from the wastewater will settle into the bottom layer C of the first compartment 4. Particles in the wastewater will form heavier particles that will settle by gravity under the quiescent conditions that are present in the first compartment 4. Grease and scum will float to the top layer A near the surface of the first compartment 4.

The first compartment 4 comprises a clarification layer B of fluid having a relatively low percentage of components having a density that differs from the density of water.

The first compartment 4 is separated from the second compartment 6 by a separation wall 42 that is provided with a number of openings or slots. In an embodiment, the separation wall 42 is formed as a perforated plate. In an embodiment, the separation wall 42 comprises a section formed as a perforated plate.

The second compartment 6 comprises a bottom layer (sludge layer) C′, a top layer A′ (floating layer) located near the surface of the second compartment 6. The second compartment 6 comprises a clarification layer B′ of fluid having a relatively low percentage of components having a density that differs from the density of water.

A flow F of fluid is flowing from the first compartment 4 to the second compartment 6 through the first separation wall 42.

Settled solids in the bottom layers C, C′ of the phase separation and clarification tank 10 and floatable solids of the top layers A, A′ of the phase separation and clarification tank 10 are kept in the phase separation and clarification tank 10 for a long period (in one embodiment, one year). Accordingly, the size of the phase separation and clarification tank 10 needs to be selected in dependency of the quantity of wastewater entering into the phase separation and clarification tank 10.

The clarified effluent from the clarification layer B′ of the second compartment is conveyed via an overflow pipe 18 to a buffer tank 90 in fluid communication with a water extraction unit 20. A pump 48 is arranged between the buffer tank 90 and the water extraction unit 20.

Concentrate from the water extraction unit 20 may enter the phase separation and clarification tank 10 through an additional pipe 16. The additional pipe 16 is connected to the inlet pipe 14. In another embodiment, however, the additional pipe 16 is connected directly to the upper part of the first compartment 4.

FIG. 2B illustrates a schematic cross-sectional view of another non-biological wastewater treatment system 2 according to an embodiment. The wastewater treatment system 2 basically corresponds to the one shown in and explained with reference to FIG. 2A. The additional compartment 6, the buffer tank 90, the pump 48 and the water extraction unit 20, however, are integrated in a tank assembly 92.

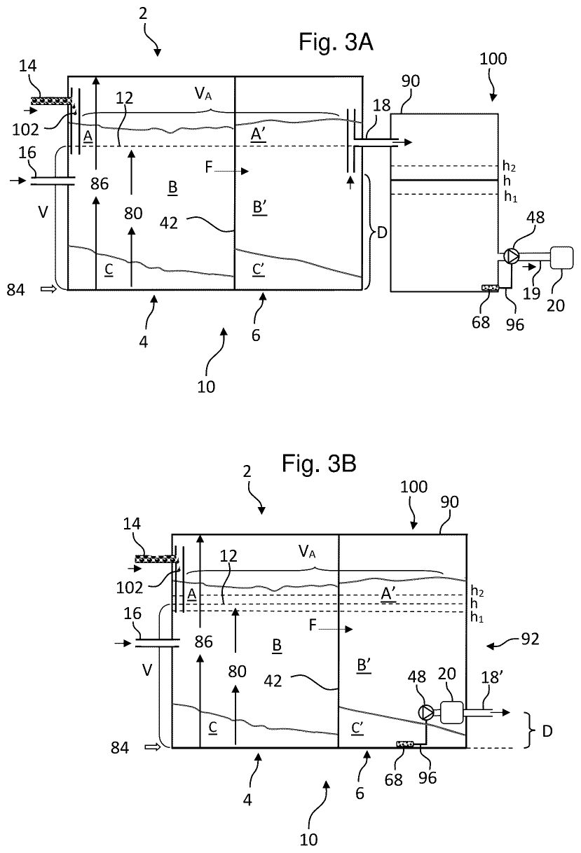

FIG. 3A illustrates a schematic cross-sectional view of a non-biological wastewater treatment system 2 according to an embodiment. The wastewater treatment system 2 basically corresponds to the one shown in FIG. 1A. Wastewater enters the phase separation and clarification tank 10 through an inlet pipe 14 that is connected to the upper part of the first compartment 4. The wastewater treatment system 2, however, comprises a separate additional pipe 16 arranged to guide concentrate to the phase separation and clarification tank 10.

FIG. 3B illustrates a schematic cross-sectional view of another non-biological wastewater treatment system 2 according to an embodiment. The wastewater treatment system 2 basically corresponds to the one shown in and explained with reference to FIG. 3A. The second additional compartment 8, the buffer tank 90, the pump 48 and the water extraction unit 20, however, are integrated in a tank assembly 92.

FIG. 4 illustrates a schematic view of a water extraction unit 20 of a non-biological wastewater treatment system according to an embodiment. The water extraction unit 20 comprises a forward osmosis water extraction unit 22 comprising one or more forward osmosis membranes. The water extraction unit 20 comprises a draw recovery system formed as a reverse osmosis water extraction unit 24 comprising one or more reverse osmosis membranes. The water extraction unit 20 comprises an open container 30 that receives brine from the reverse osmosis water extraction unit 24.

Wastewater (feed solution) from the phase separation and clarification tank of the wastewater treatment system (see FIG. 1A, FIG. 2A or FIG. 3A) enters the water extraction unit 20 through an inlet line 32.

Diluted draw solution leaves the forward osmosis water extraction unit 22 via a fluid line 26 and is pumped to the reverse osmosis water extraction unit 24 by a pump 50. The pump 50 generates the required pressure to separate the salts from the other solutes from the permeate water over a semi-permeable membrane in the reverse osmosis water extraction unit 24. A pressure recovery device 94 is arranged between the reverse osmosis water extraction unit 24 and the container 30. The pressure recovery device 94 is mechanically connected to the pump 50 such that pressure energy recovered by the pressure recovery device 94 is converted to mechanical energy that is transferred by a mechanical connection 98 to the pump 50.

Permeate leaves the reverse osmosis water extraction unit 24 via an outlet line 36. The permeate is so clean that it can be released back into the environment (e.g. lakes or streams).

Brine from the reverse osmosis water extraction unit 24 leaves the reverse osmosis water extraction unit 24 via a fluid line 28. The fluid line 28 is connected to and guides brine to the open container 30. Brine released from the distal end of the fluid line 28 falls into the water in the container 30. The fall height H is indicated in FIG. 4. It can be seen that the level of the water surface 44 can vary between a lower level L₁ and an upper level L₂. An incoming air flow 38 enters the opening of the container 30 and flows along the water surface 44 before it leaves the container 30 as an outgoing air flow 38′. The incoming air 38 may be generated by natural ventilation and/or by a fan 62. The fan 62 shown in FIG. 4 is optional.

The container 30 comprises a suitable draw solution. In an embodiment, the draw solution is saltwater.

Hydrogen sulfide (H₂S) may occasionally be present at a wastewater treatment system. An unpleasant rotten-egg odor can be registered in H₂S concentrations as low as 0.01 ppm. Frequent H₂S issues form the basis for an unhealthy and even dangerous work environment at wastewater treatment systems. Prolonged exposure to H₂S concentrations in the range 2-5 ppm can cause nausea, tearing of the eyes, headache, and breathing problems. Exposure to concentrations above 20 ppm may cause fatigue, loss of appetite, headache, irritability, and dizziness. At 100-150 ppm, H₂S can no longer be registered by the human nose, and at concentrations above 500 ppm H₂S causes eye damage, rapid unconsciousness, and death. Accordingly, H₂S is a problem of major health concern.

Moreover, the corrosive properties of H₂S are well-established. H₂S gas is converted into sulfuric acid when sulfate-reducing bacteria in the biofilm on concrete surfaces reacts with the gas. This starts a corrosion attack that slowly converts otherwise healthy concrete constructions into fragile plaster.

By releasing free-falling brine 40 from the distal end of the fluid line 28 and hereby letting the brine fall into the water in the container 30, it is possible to generate a sufficiently large degree of turbulence and surface interaction to draw H₂S out of the water phase of the container 30 into the air phase of the container 30. There is an equilibrium concentration between H₂S in the water phase and H₂S in the air phase. According to Henry's law the amount of dissolved gas in a liquid is directly proportional to its partial pressure above the liquid. By ventilating the air above the water surface 44 of the container 30, fresh air is constantly supplied to the top portion of the container 30 and H₂S is removed from the air. Accordingly, it is possible to keep the concentration of H₂S close to zero in the air phase.

Alternatively, ventilation can be created by using mechanical devices such as a stirring device or a mixer 88. The mixer shown in FIG. 4 is optional.

A line 46 connects the container 30 and the forward osmosis water extraction unit 22. Draw solution flows from the container 30 via the line 46 to the forward osmosis water extraction unit 22. Concentrate from the forward osmosis water extraction unit 22 enters the tank of the wastewater treatment system (see FIGS. 1A, 1B, 2A, 2B, 3A and 3B) via the outlet line 34.

The forward osmosis water extraction unit 22 and the reverse osmosis water extraction unit 24 are connected directly via the open container 30. Accordingly, the forward osmosis water extraction unit 22 will automatically adjust to the same liquid flow as permeate is drawn from the reverse osmosis water extraction unit 24. With increasing resistance across the membrane(s) of the forward osmosis water extraction unit 22, the water level 44 in the container 30 will drop until the concentration becomes so high that the balance is restored. Moreover, if the water level 44 in the container is below the predefined lower level L₁, it indicates that an additional amount of salt has to be filled into the container 30.

In another embodiment, the container 30 is arranged between the forward osmosis water extraction unit 22 and the reverse osmosis water extraction unit 24.

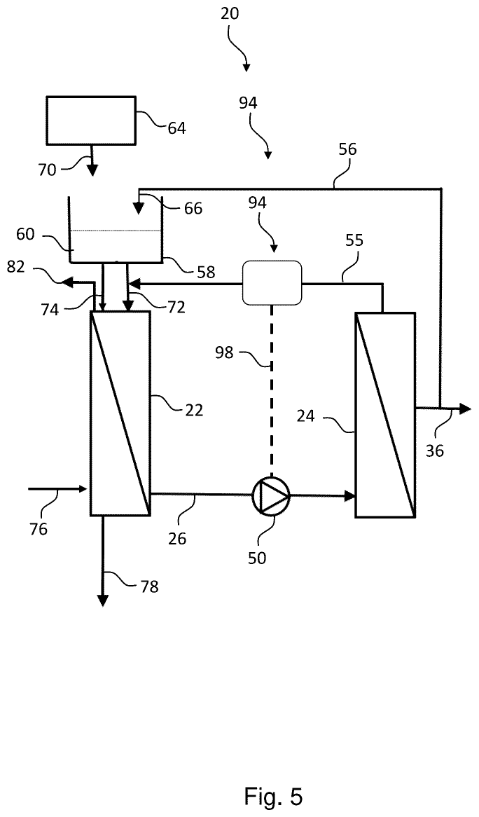

FIG. 5 illustrates a schematic view of another water extraction unit 20 of a non-biological wastewater treatment system according to an embodiment. The water extraction unit 20 comprises a forward osmosis water extraction unit 22 comprising one or more forward osmosis membranes. The water extraction unit 20 comprises a draw recovery system formed as a reverse osmosis water extraction unit 24 comprising one or more reverse osmosis membranes. The water extraction unit 20 comprises an open container 58 that receives permeate from the reverse osmosis water extraction unit 24.

Wastewater (feed solution) from the phase separation and clarification tank of the wastewater treatment system (see FIG. 1A, 1B, FIG. 2A, 2B or FIG. 3A, 3B) enters the forward osmosis water extraction unit 22 of the water extraction unit 20 through an inlet line 76. A drain line 78 is connected to the forward osmosis water extraction unit 22.

Diluted draw solution leaves the forward osmosis water extraction unit 22 via a fluid line 26 and is pumped to the reverse osmosis water extraction unit 24 by a pump 50. The pump 50 pressurizes the water before the water enters the reverse osmosis water extraction unit 24.

Permeate leaves the reverse osmosis water extraction unit 24 via an outlet line 36. The outlet line 36 is connected to a line 56 that has a distal outlet 66. The distal outlet 66 delivers liquid to the container 58. Alternatively, the container 58 may be separated into a first part and a second part formed as two separate containers.

The container 58 receives permeate from the outlet of the reverse osmosis water extraction unit 24 via the line 56. The container 58 is connected to the draw side of the forward osmosis water extraction unit 22 via a line 72.

The container 58 is connected to the feed side of the forward osmosis water extraction unit 22 via a line 74.

Optionally, the container 58 is supplied with a biocide which is supplied separately or mixed with the permeate. The biocide may be stored in a vessel 64 having an outlet 70 arranged and configured to supply biocide into the container 58.

In an embodiment, the method comprises the step of adding biocide to the permeate in the container 58 before the permeate is used.

By the term biocide is meant a chemical substance or microorganism intended to destroy, deter, render harmless, or exert a controlling effect on any harmful organism. The biocide may be a pesticide such as fungicides, herbicides, insecticides, algicides, molluscicides, miticides, piscicides, rodenticides, and slimicides. The biocide may be an antimicrobial such as germicides, antibiotics, antibacterials, antivirals, antifungals, antiprotozoals, and antiparasites.

Brine from the reverse osmosis water extraction unit 24 leaves the reverse osmosis water extraction unit 24 via a fluid line 55. The fluid line 55 is connected to and guides brine to the line 72 between the container 58 and the draw side of the forward osmosis water extraction unit 22.

An outlet line 82 is connected to the forward osmosis water extraction unit 22. Concentrate from the forward osmosis water extraction unit 22 enters the tank of the wastewater treatment system (see FIG. 1A, 1B, FIG. 2A, 2B and FIG. 3A, 3B) via the outlet line 82.

A pressure recovery device 94 is arranged between the reverse osmosis water extraction unit 24 and the line 72. The pressure recovery device 94 is mechanically connected to the pump 50 such that pressure energy recovered by the pressure recovery device 94 is converted to mechanical energy that is transferred by a mechanical connection 98 to the pump 50.

In an embodiment, the method according to the present disclosure comprises a stop procedure comprising the following steps I, II and III.

In step I, the recirculation pump 50 sucks permeate from the tank of the wastewater treatment system (shown in FIG. 1A, FIG. 2A and FIG. 3A) through the forward osmosis water extraction unit 22 and the reverse osmosis water extraction unit 24. The pump 50 stops when the permeate has reached the outlet of the reverse osmosis water extraction unit 24.

The osmotic pressure difference across the membrane(s) of the forward osmosis water extraction unit 22 reverses, so that water from the draw side of the forward osmosis water extraction unit 22 is driven towards the feed side of the forward osmosis water extraction unit 22. Hereby, an osmotic “backwash” effect is achieved.

The osmotic pressure difference across the membrane(s) of the reverse osmosis water extraction unit 24 is equalized to nearly zero. Hereby, the concentrations of contaminants on the permeate side of the reverse osmosis water extraction unit 24 do not change during the following period in which the pump is shut off (otherwise the concentrations of contaminants on the permeate side of the reverse osmosis water extraction unit 24 could increase).

By sending permeate water through fluid line 55 and line 56, the draw circuit is not contaminated.

In step II, the backwash is running for a predefined time period to allow the osmotic pressure difference across the membrane(s) of the forward osmosis water extraction unit 24 to be equalized to nearly zero. In an embodiment, the time period is 30 minutes.

The backwash will cause some of the membrane fouling to come loose. Hereby, the backwash positively contributes to keeping the membrane clean.

In step III, the wastewater is now drained out of the feed side of the forward osmosis water extraction unit 22 while the forward osmosis water extraction unit 22 is subsequently filled with permeate water from the first part 60 of the container 58. At regular intervals or when the wastewater treatment system is down for a long time, this may be combined with addition of biocide to the second part 64.

By carrying out this drainage, particles and fouling that has come loose are removed from the membrane(s) of the forward osmosis water extraction unit 22. In the subsequent relaxation of the membrane(s) of the forward osmosis water extraction unit 22, less fouling occurs. This will contribute to keeping fouling of the membrane(s) of the forward osmosis water extraction unit 22 under control. Biocide will ensure against biofilm growth inside the membrane(s) of the forward osmosis water extraction unit 22. By applying these method steps, it is possible to keep the wastewater treatment system ready to be started and operated stably over a long period of time.

By using permeate water, salt is not returned to the feed side of the forward osmosis water extraction unit 22 (and thus to the tank). After carrying out said method steps, the wastewater treatment system is ready to start again and/or to standby for a longer period of time.

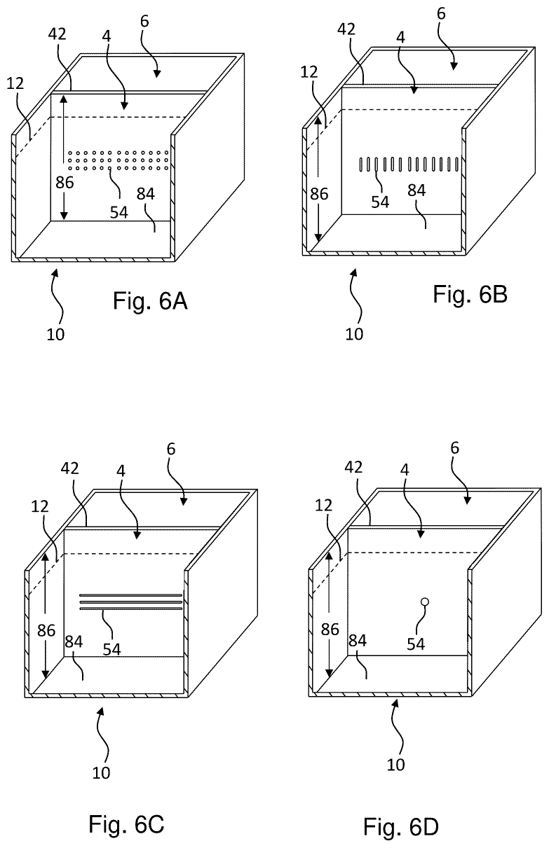

FIG. 6A illustrates a cross-sectional view of a phase separation and clarification tank 10 of a wastewater treatment system according to an embodiment. The phase separation and clarification tank 10 comprises a bottom 84 and side walls extending therefrom. The phase separation and clarification tank 10 comprises a first compartment 4 and an additional compartment 6. A separation wall 42 separates the first compartment 4 and the second compartment 6.

The height 86 of the separation wall 42 corresponds to the height of the phase separation and clarification tank 10. Accordingly, the fluid flowing from the first compartment 4 to the additional compartment 6 must pass through the openings 54 provided in the separation wall 42. The openings 54 are provided in the separation wall 42 at a distance from the bottom 84 corresponding to one third to two thirds of the depth of wastewater. The water level 12 is indicated.

The openings 54 are circular. The openings 54 may, however, have other shapes. The openings 54 may be rectangular, triangular, or oval.

FIG. 6B illustrates a cross-sectional view of a phase separation and clarification tank 10 of a wastewater treatment system according to an embodiment. The phase separation and clarification tank 10 basically corresponds the one shown in FIG. 6A. The tank 10 comprises a separation wall 42 provided with elongated openings 54 arranged in a single row. It is possible to have several rows of openings.

FIG. 6C illustrates a cross-sectional view of a tank 10 of a wastewater treatment system according to an embodiment. The phase separation and clarification tank 10 basically corresponds to the one shown in FIG. 6A. The phase separation and clarification tank 10 comprises a separation wall 42 provided with elongated openings 54 extending horizontally.

FIG. 6D illustrates a cross-sectional view of a phase separation and clarification tank 10 of a wastewater treatment system according to an embodiment. The phase separation and clarification tank 10 basically corresponds the one shown in FIG. 6A. The phase separation and clarification tank 10, however, comprises a separation wall 42 provided with a single opening 54 only.

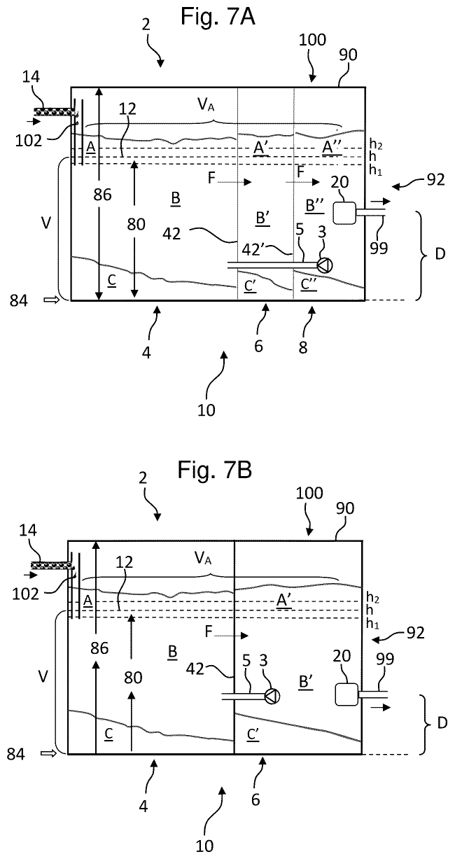

FIG. 7A illustrates a schematic cross-sectional view of a non-biological wastewater treatment system 2 according to an embodiment. The wastewater treatment system 2 basically corresponds to the one shown in and explained with reference to FIG. 1B. The water extraction unit 20, however, is not connected to any pump. Moreover, the water extraction unit 20 has direct access to the phase separation and clarification tank 10. Accordingly, no additional pipe (like the additional pipe 16 shown in FIG. 1A and FIG. 1B) is required to guide water from the water extraction unit 20 to the phase separation and clarification tank 10. The water extraction unit 20 is connected to an outlet 99 that extends out of the outermost additional compartment 8.

The wastewater treatment system 2 comprises a circulation pump 3 arranged and configured to pump wastewater 102 from the buffer tank 90 to the first compartment 4 via a guide structure 5. The guide structure 5 may be formed as a pipe. The circulation pump 3 is arranged and configured to ensure that wastewater 102 (concentrate) is recirculated from the outermost additional compartment 8 to the first compartment 4 in such a manner that the concentration is equal in the first compartment 4 and the additional compartments 6, 8.

The water extraction unit 20 may comprise flat sheet membranes.

FIG. 7B illustrates a schematic cross-sectional view of a further non-biological wastewater treatment system 2 according to an embodiment. The wastewater treatment system 2 basically corresponds to the one shown in and explained with reference to FIG. 7A. Compared to FIG. 7A, however, the two additional compartments 6, 8 are integrated to a single additional compartment 6.

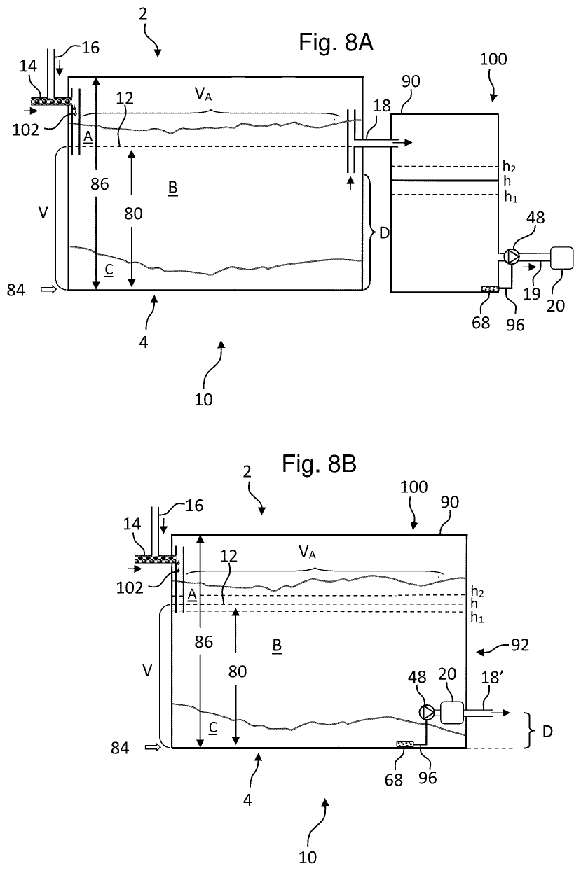

FIG. 8A illustrates a schematic cross-sectional view of a non-biological wastewater treatment system 2 according to an embodiment. The wastewater treatment system 2 basically corresponds to the one shown and explained with reference to FIG. 1A. The phase separation and clarification tank 10, however, comprises a single compartment 4 only.

FIG. 8B illustrates a schematic cross-sectional view of a non-biological wastewater treatment system 2 according to an embodiment. The wastewater treatment system 2 basically corresponds to the one shown in and explained with reference to FIG. 1B. The phase separation and clarification tank 10, however, comprises a single compartment 4 only.

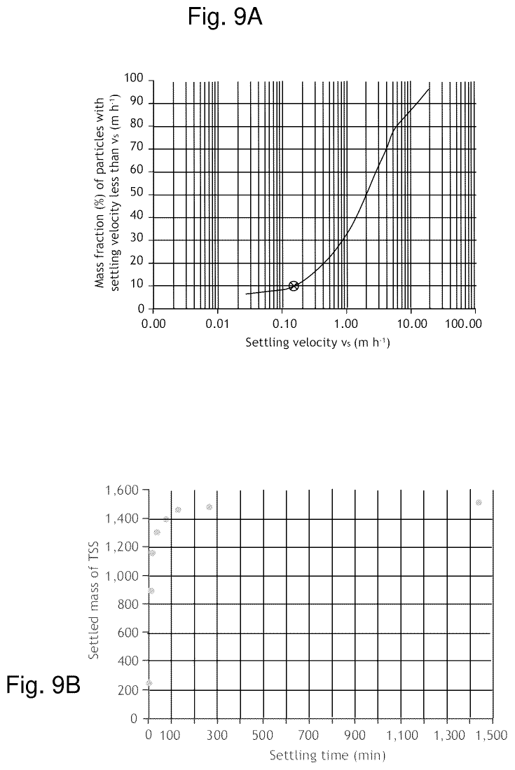

FIG. 9A illustrates a graph depicting the mass fraction (%) of particles as a function of the settling velocity V_{S}. It can be seen that only 10% of the mass fraction (%) of particles will not settle at the settling velocity V_{S} of 0.15 m h⁻¹ indicated with a circle with a cross. Please note that the velocity m h⁻¹ corresponds to m/hours.

Accordingly, 90% of the mass fraction of particles will settle at the indicated settling velocity V_{S} of 0.15 m h⁻¹. This means that only the very light and small particles will not settle. The wastewater containing these particles will flow to the water extraction unit connected to the phase separation and clarification tank.

FIG. 9B illustrates a graph depicting the settled mass of the total suspended solids (TSS) as a function of the settling time. It can be seen that the graph rises very fast and reaches a plateau after about 2-3 hours. Therefore, a time period of 3 hours will be sufficient to settle the majority of the TSS.

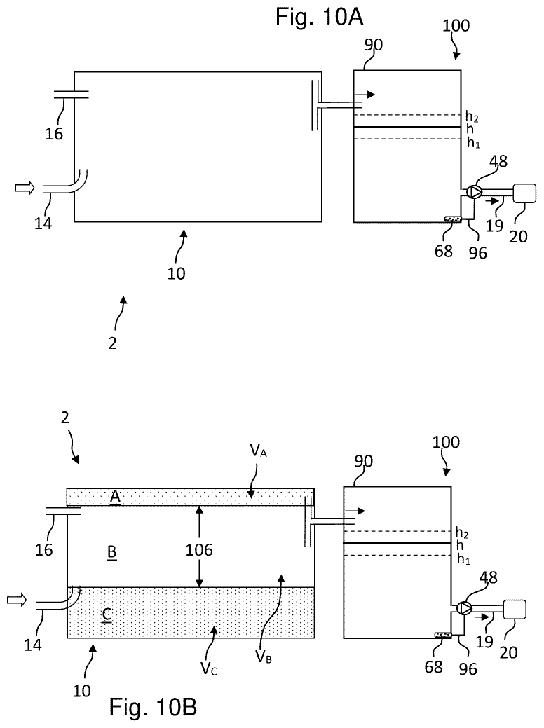

FIG. 10A illustrates a schematic cross-sectional view of a non-biological wastewater treatment system 2 according to an embodiment. The wastewater treatment system 2 basically corresponds to the one shown in and explained with reference to FIG. 1A. The phase separation and clarification tank 10, however, comprises a single compartment 4 only. In another embodiment, however, the phase separation and clarification tank 10, however, comprises several compartments 4.

No sludge has yet settled in the phase separation and clarification tank 10 because the non-biological wastewater treatment system 2 has not been used yet. Accordingly, no sludge has yet been settled on the bottom of the phase separation and clarification tank 10. Likewise, no floating sludge is present in the top layer (floating layer) of the phase separation and clarification tank 10.

The phase separation and clarification tank 10 comprises an inlet 14 for introducing wastewater into the phase separation and clarification tank 10. The phase separation and clarification tank 10 comprises an additional pipe 16 (for concentrate from the water extraction unit 20).

FIG. 10B illustrates the non-biological wastewater treatment system 2 shown in FIG. 10A in a state at which sludge in the phase separation and clarification tank 10 needs to be removed.

When designing the non-biological wastewater treatment system 2, one would typically select the capacity of the non-biological wastewater treatment system 2 in dependency of the intended use scenario. Typically, one would select the volume of the phase separation and clarification tank 10 such that sludge settled in the phase separation and clarification tank 10 needs to be removed once a year. The cleaning frequency may, however, be selected differently (e.g. twice a year).

If the requirement defines that the sludge settled in the phase separation and clarification tank 10 needs to be removed once a year one can calculate the expected total volume V_{A} of floating sludge in the top layer A in a household with N persons is defined by the following equation (1):

V_{A}=N*60 liters (1)

In a typical household having five persons, the total volume V_{A} of the top layer A will be 300 liters.

Likewise, if the requirement defines that the sludge settled in the phase separation and clarification tank 10 needs to be removed once a year one can calculate the expected total volume V_{C} of bottom sludge in the bottom layer C in a household with N persons is defined by the following equation (2):

V_{C}=N*180 liters (2)

In a typical household having five persons, the total volume V_{C} of the bottom layer C will be 900 liters.

The total volume V_{B} of the clarification layer B should be large enough for the phase separation and clarification tank 10 to settle enough particles even after one year. Two criteria need to be fulfilled:
criterion a) the retention time R needs to be at least 3 hours (as shown in and explained with reference to FIG. 9B); and
criterion b) the settling velocity V_{S} must be sufficiently low to ensure that a predefined percentage Pₚᵣₑ of the mass fraction of particles will settle.

In an embodiment, the predefined percentage Pₚᵣₑ of the mass fraction of particles is 90%. In this embodiment, one can by using FIG. 9A deduce that at the indicated settling velocity V_{S} of 0.15 m h⁻¹ 90% of the mass fraction of particles will settle.

The quantity of wastewater produced per person is typically 150 liter/day. A five person family will be expected to produce 750 liters of wastewater each day. Accordingly, after one year when the total volume V_{A} of the top layer A of the phase separation and clarification tank 10 and the total volume V_{C} of the bottom layer of the phase separation and clarification tank 10 have reached their upper allowable limits, the total volume V_{B} of the clarification layer B of the phase separation and clarification tank 10 must still be large enough to allow the clarification process in the phase separation and clarification tank 10 to carry on in an efficient manner.

If one decides to have a one-day capacity, total volume V_{B} of the clarification layer B of the phase separation and clarification tank 10 must be 750 liters.

Accordingly, the total volume of the phase separation and clarification tank 10 must be V_{A}+V_{B}+V_{C}=300 L+750 L+900 L=1950 L.

To ensure that settling velocity V_{S} is sufficiently low to ensure that a predefined percentage Pₚᵣₑ of the mass fraction of particles will settle, the following equation (3) must be fulfilled:

V_{S}≤0.15 m h⁻¹ (3)

Since the particles in the wastewater must settle in the vertical direction. The retention time R depends on the travelling height 106 indicated in FIG. 10B. It can be seen that the travelling height 106 corresponds to the height of the clarification layer B of the phase separation and clarification tank 10. The relationship between the retention time R, the travelling height 106 and the V_{S} is given by:

R*V_{S}=travelling height (4)

The ratio between the surface area and the volume V_{B} of the clarification layer B of the phase separation and clarification tank 10 would typically be in the range 0.6-0.9 m²/m³. If the volume V_{B} of the clarification layer B of the phase separation and clarification tank 10 is increased to 750 L and the surface area is 0.68 m², the travelling height is given by:

travelling height106=0.75 m³/0.68 m²=1.10 m. (5)

The surface loading rate=average flow/surface area=(0.75 m³/day)/(0.68 m²)=(0.03125 m³/hour)/(0.68 m²)=0.046 m/hour (6)

With these values, we can calculate if criterion a) and criterion b) are fulfilled.

The retention time R is defined by equation (7):

R=V_{B}/Q_{average}=750 L/(750 L/day)=24 hours. (7)

Accordingly, criterion a) is fulfiled (since R is more than 3 hours)

The settling velocity V_{S} can be calculated by using equation (4):

R*V_{S}=travelling height⇒V_{S}=travelling height/R (4)

We find that:

V_{S}=travelling height/R=1.1 m/24 hours=0.046 m/hour (4)

Accordingly, criterion b) is fulfilled since V_{S} is lower than 0.15 m/hour.

A method according to the present disclosure may comprise the following steps:
designing the volume of the phase separation and clarification tank 10 of the non-biological wastewater treatment system 2 in dependency of the expected average 24-hour wastewater production (Q_{average}) to be received by the wastewater treatment system 2 such that:
a) the non-biological wastewater treatment system 2 can be operated without removing sludge from a bottom layer(s) C, C′, C″ of the phase separation and clarification tank 10 for a predefined operation period (e.g. one year);
selecting a predefined percentage Pₚᵣₑ of the mass fraction of particles (percentage of particles, e.g. 90%) that should be settled;
determining a settling velocity V_{S} at which the selected percentage of particles does settle;
dimensioning the phase separation and clarification tank 10 in a manner in which after the predefined operation period (e.g. one year):
a) the retention time (R) is at least 2 hours; and
b) the settling velocity V_{S} is sufficiently low to ensure that the predefined percentage Pₚᵣₑ of the mass fraction of particles will settle.

### LIST OF REFERENCE NUMERALS

2 Non-biological wastewater treatment system
3 Circulation pump
4 First compartment
5 Line
6 Second compartment
8 Third compartment
10 Phase separation and clarification tank
12 Water level
14 Inlet pipe
16 Additional pipe (for concentrate from the forward osmosis water extraction unit)
18 Overflow pipe
18′ Outlet pipe
19 Outlet pipe (guiding feed to the forward osmosis water extraction unit)
20 Water extraction unit
22 Forward osmosis water extraction unit
24 Reverse osmosis water extraction unit
26 Fluid line (diluted draw fluid line)
28 Fluid line (brine fluid line)
30 Container
32 Inlet line for the forward osmosis water extraction unit (guiding feed to the forward osmosis water extraction unit)
34 Outlet line for the forward osmosis water extraction unit (guiding concentrate from the forward osmosis water extraction unit)
36 Outlet line (guiding permeate from the reverse osmosis water extraction unit)
38 Incoming air flow
38′ Outgoing air flow
40 Free-failing brine
42, 42′ Separation wall (e.g. a perforated plate)
44 Water surface
46 Line (draw fluid line)
48, 50, 52 Pump
54 Opening
55 Fluid line (brine fluid line)
56 Line (permeate fluid line)
58 Open container
60 First part (containing permeate)
62 Fan
64 Vessel
66 Distal outlet
68 Water level sensor
70 Outlet
72, 74 Line
76 Inlet line (guiding feed to the forward osmosis water extraction unit)
78 Feed inlet (guiding feed to and drain from the forward osmosis water extraction unit)
80 Water level height
82 Line (guiding concentrate from the forward osmosis water extraction unit)
84 Bottom
86 Height
88 Mixer
90 Buffer tank
92 Tank assembly
94 Pressure recovery device
96 Wire
98 Mechanical connection
99 Line (outlet)
100 Control system
102 Wastewater
104 Ventilation assembly
106 Travelling height
A, A′, A″ Top layer (floating layer)
B, B′, B″ Clarification layer (to be filtrated)
C, C′, C″ Bottom layer (sludge layer)
F, F′ Flow across separation wall
L₁ Lower water level
L₂ Upper water level
H Fall height
h, h₁, h₂ Water level of the buffer tank
V Wet volume of the phase separation and clarification tank
V_{A} Total volume of the top layer of the phase separation and clarification tank
V_{B} Total volume of the clarification layer of the phase separation and clarification tank
V_{C} Total volume of the bottom layer of the phase separation and clarification tank
V_{S} Settling velocity
Pₚᵣₑ A predefined percentage of the mass fraction of particles
Q_{Average} Flow
U Average velocity of the wastewater in the phase separation and clarification tank
A_{C} Cross-sectional area of the phase separation and clarification tank (perpendicular to average velocity of the wastewater in the phase separation and clarification tank)
R Retention time

What is claimed is:

1. A non-biological wastewater treatment system comprising:
a water extraction unit having a forward osmosis water extraction unit and a draw recovery system that is connected to and configured to receive a diluted draw solution from the forward osmosis water extraction unit;
a phase separation and clarification tank having a volume and comprising an inlet configured to receive wastewater to be treated by the non-biological wastewater treatment system, wherein the inlet is connected to a first compartment; and
a buffer tank arranged and configured to receive wastewater from an outlet structure of the phase separation and clarification tank,
wherein the volume of the phase separation and clarification tank is selected in dependency of a predefined operation period and an expected wastewater production to be received by the non-biological wastewater treatment system such that the non-biological wastewater treatment system is configured to be operated without removing sludge from a bottom layer of the phase separation and clarification tank for the predefined operation period; and
wherein:
a predefined percentage of a mass fraction of particles that should be settled in the phase separation and clarification tank is selected;
a settling velocity at which the selected percentage of particles settles is determined; and
the phase separation and clarification tank is dimensioned such that, after the predefined operation period:
a) retention time is at least 2 hours; and
b) the settling velocity allows the predefined percentage of the mass fraction of particles to settle in the phase separation and clarification tank.

2. The non-biological wastewater treatment system according to claim 1, wherein the wastewater treatment system is configured to ensure that an average flow of the wastewater through the phase separation and clarification tank causes the retention time of the wastewater to be at least 12 hours in the phase separation and clarification tank, wherein the water extraction unit is arranged and configured to receive wastewater from a clarified layer of the phase separation and clarification tank.

3. The non-biological wastewater treatment system according to claim 1, wherein the phase separation and clarification tank has one or more additional compartments, wherein each compartment is separated from adjacent compartments by a separation wall provided with one or more openings.

4. The non-biological wastewater treatment system according to claim 1, wherein the wastewater in the first compartment comprises a water level that is maintained within a fixed predefined range so that fluctuation of the water level is less than 20% of a wet volume of the phase separation and clarification tank.

5. The wastewater treatment system according to claim 1, wherein the buffer tank is connected to the water extraction unit;
a water level sensor is arranged and configured to detect a water level in the buffer tank; and
a pump and the water extraction unit are arranged and configured to maintain the water level in the buffer tank within a predefined upper level and a predefined lower range.

6. The wastewater treatment system according to claim 5, wherein:
the buffer tank is integrated in the phase separation and clarification tank, a circulation pump is arranged in the buffer tank, and
the circulation pump is arranged and configured to pump wastewater from the buffer tank to the first compartment via a guide structure.

7. The wastewater treatment system according to claim 1, wherein the draw recovery system is formed as a reverse osmosis water extraction unit.

8. The wastewater treatment system according to claim 3, wherein a ratio between a total surface area of the first and one or more additional compartments and a total volume of the first and one or more additional compartments is in a range 0.6-0.9 m²/m³.

9. The wastewater treatment system according to claim 1, wherein a cross-sectional area of the outlet structure is equal to or larger than an area of the inlet.

10. The wastewater treatment system according to claim 1, wherein the forward osmosis water extraction unit and the draw recovery system are connected directly via a fluid line and via an open container containing water that contains a concentration of dissolved salt, wherein the open container is arranged and configured to provide ventilation that removes air above the water in the open container and introduces atmospheric air into an area above the water in the open container, wherein ventilation is provided by:
a) brine from the draw recovery system, wherein the brine leaves the draw recovery system via the fluid line, wherein the fluid line is connected to and guides the brine to the open container, wherein the brine is released from a distal end of the fluid line and falls into the water in the open container; and
b) a ventilation assembly arranged and configured to ventilate a surface of the water in the open container.

11. The wastewater treatment system according to claim 1, wherein the wastewater treatment system is configured to maintain a ratio between a flow of fluid entering the draw recovery system and a permeate flow of purified fluid leaving the wastewater treatment system through an outlet line within a predefined range that fluctuates less than 20%.

12. The wastewater treatment system according to claim 10, wherein a flow of the brine released from the distal end of the fluid line is higher than or equal to a flow of fluid in an outlet line.

13. The wastewater treatment system according to claim 10, wherein the open container is provided with:
a mixer arranged and configured to provide turbulence to draw hydrogen sulfide out of the water in the open container into the air above the water; and/or
a fan arranged and configured to ventilate a surface of the water in the open container.

14. A method for treating wastewater using a non-biological wastewater treatment system, the method comprising:
providing the non-biological wastewater treatment system of claim 1;
selecting a predefined operation period and designing a volume of the phase separation and clarification tank of the non-biological wastewater treatment system in dependency of an expected wastewater production to be received by the wastewater treatment system such that the non-biological wastewater treatment system can be operated without removing sludge from a bottom layer of the phase separation and clarification tank for the predefined operation period;
selecting a predefined percentage of a mass fraction of particles that should be settled in the phase separation and clarification tank;
determining a settling velocity at which the selected percentage of particles settles;
dimensioning the phase separation and clarification tank such that, after the predefined operation period:
a) retention time is at least 2 hours; and
b) the settling velocity allows the predefined percentage of the mass fraction of particles to settle in the phase separation and clarification tank.

15. The method according to claim 14, further comprising ensuring that a flow of the wastewater through the phase separation and clarification tank causes the retention time of the wastewater to be at least 12 hours in the phase separation and clarification tank.

16. The method according to claim 14, further comprising ensuring that the wastewater in the first compartment comprises a water level that is maintained within a fixed predefined range so that fluctuation of the water level is less than 20% of a wet volume of the phase separation and clarification tank.

17. The method according to claim 16, wherein the buffer tank is connected to the water extraction unit and the method further comprises:
detecting a water level of the buffer tank; and
maintaining the water level of the buffer tank within a predefined upper level and a predefined lower range such that fluctuation of the water level in the buffer tank is less than 20% of a wet volume of the buffer tank.

18. The method according to claim 16, wherein:
the buffer tank is integrated in the phase separation and clarification tank, the water extraction unit is configured to maintain the water level in the buffer tank within a predefined upper level and a predefined lower range,
a circulation pump is arranged in the buffer tank, and
the circulation pump is arranged and configured to pump wastewater from the buffer tank to the first compartment via a guide structure.

19. The method according to claim 14, wherein the water extraction unit comprises an open container arranged and configured to receive brine from the forward osmosis water extraction unit, and the method further comprises applying a backwash procedure in which a recirculation pump arranged and configured to suck permeate from an open container through the forward osmosis water extraction unit and the draw recovery system is stopped when permeate from the open container has reached an outlet of the draw recovery system.

20. The method according to claim 19, wherein the water extraction unit comprises an open container arranged and configured to receive permeate water from the reverse osmosis water extraction unit, wherein wastewater is drained or displaced out of a feed side of the forward osmosis water extraction unit while the forward osmosis water extraction unit is subsequently filled with the permeate water from a first part of the open container.
